(19) United States
(12) Patent Application Publication
(10) Pub. No.: US 2026/0217070 A1
(43) Pub. Date: Jul. 30, 2026

(54) TOW HOOK ASSEMBLY FOR A VEHICLE

(71) Applicant: Ford Global Technologies, LLC, Dearborn, MI (US)

(72) Inventors: Raul Sanchez Hernandez, Benito Juarez (MX); Jaciel Leon, Los Heroes Coacalco (MX); Cesar Navarro, Naucalpan (MX); Iván Nava Cardeño, Metepec (MX)

(73) Assignee: Ford Global Technologies, LLC, Dearborn, MI (US)

(21) Appl. No.: 19/039,140

(22) Filed: Jan. 28, 2025

(51) Int. Cl. B60D 1/04; B60D 1/54; B60R 19/54

(52) U.S. Cl. CPC B60D 1/04; B60D 1/54; B60D 2001/544; B60R 19/54

(57) ABSTRACT

A tow hook assembly for a vehicle that includes a bracket, a tow loop, and a biasing mechanism. The bracket is configured to be coupled to a body of the vehicle. The tow loop is rotatably coupled to the bracket between a stowed position and a deployed position. The biasing mechanism is configured to bias the tow loop towards the stowed position and includes a biasing member and at least one washer having a plurality of teeth. The biasing member engaging a first tooth of the plurality of teeth when the tow loop is in the stowed position to inhibit movement of the tow loop in a first rotational direction.

### FIELD

The present disclosure relates to a tow hook assembly for a vehicle, and, more particularly, a vehicle including a tow hook assembly.

### BACKGROUND

The statements in this section merely provide background information related to the present disclosure and may not constitute prior art.

Some vehicles include attachment points (e.g., tow hooks) for vehicle accessories that allow for enhancing the vehicle’s functionality. In some forms, the attachment points may connect to straps that allow for the towing of a vehicle. In other forms, the attachment points may connect to a nudge bar, example, which provides further shielding of the vehicle. Traditional attachment points lack functionality, which may affect the assembly of the vehicle and/or the assembly of accessories to the vehicle.

The teachings of the present disclosure address these and other issues with attachment points used in some vehicles.

### SUMMARY

This section provides a general summary of the disclosure and is not a comprehensive disclosure of its full scope or all of its features.

In one form, the present disclosure provides a tow hook assembly for a vehicle that includes a first bracket, a tow loop, and a biasing mechanism. The first bracket is configured to be coupled to a body of the vehicle. The tow loop is rotatably coupled to the first bracket between a stowed position and a deployed position. The biasing mechanism is configured to bias the tow loop towards the stowed position and includes a biasing member and at least one washer having a plurality of teeth. The biasing member engaging a first tooth of the plurality of teeth when the tow loop is in the stowed position to inhibit movement of the tow loop in a first rotational direction.

In variations of the tow hook assembly of the above paragraph, which can be implemented individually or in any combination: the biasing member is coupled to the first bracket and the at least one washer is coupled to the tow loop; the washer is rotationally fixed to the tow loop; the tow hook assembly further includes a second bracket fixed to the first bracket and a pin extending partially through the second bracket and the tow loop such that the tow loop is rotatably coupled to the first and second brackets; the washer is disposed between the second bracket and the tow loop; the tow loop includes a first arm and a second arm that is spaced apart from the first arm; the washer includes a first washer and a second washer, the first washer rotationally fixed to the first arm of the tow loop and the second washer rotationally fixed to the second arm of the tow loop; the biasing member engages the first tooth of the plurality of teeth when the tow loop is in the deployed position to inhibit movement of the tow loop in a second rotational direction that is opposite the first rotational direction; the tow loop includes a body portion and an attachment portion extending from the body portion, the attachment portion is configured to be coupled to the first bracket when the tow loop is in the deployed position to further inhibit movement of the tow loop relative to the first bracket; the tow loop includes a connecting portion and first and second arms extending from opposing ends of the connecting member, the tow loop further includes an attachment portion extending from one of the first and second arms and configured to be coupled to the first bracket when the tow loop is in the deployed position to further inhibit movement of the tow loop relative to the first bracket; the tow loop includes an aperture that is configured to receive a fastener to couple the tow loop to a nudge bar; the first bracket and a periphery of the tow hook defines a first distance when the tow hook is in the stowed position, the first bracket and the periphery of the tow hook defines a second distance when the tow hook is in the deployed position, the second distance is greater than the first distance; and the biasing member engages a second tooth of the plurality of teeth when the tow loop is in the stowed position to inhibit movement of the tow loop in a second rotational direction that is opposite the first rotational direction.

In another form, the present disclosure provides a tow hook assembly for a vehicle that includes a first bracket, a tow loop, and a biasing mechanism. The first bracket is configured to be coupled to a body of the vehicle. The tow loop is rotatably coupled to the first bracket between a stowed position in which the first bracket and a periphery of the tow hook defines a first distance and a deployed position in which the first bracket and the periphery of the tow hook defines a second distance. The second distance greater than the first distance. The biasing mechanism is configured to bias the tow loop towards the stowed position. The biasing mechanism includes a biasing member coupled to the first bracket and at least one washer coupled to the tow loop and having a plurality of teeth. The biasing member engages the plurality of teeth when the tow loop is in the stowed position to inhibit movement of the tow loop in a first rotational direction and a second rotational direction that is opposite the first rotational direction.

In variations of the tow hook assembly of the above paragraph, which can be implemented individually or in any combination: the washer is rotationally fixed to the tow loop; a second bracket fixed to the first bracket; a pin extends partially through the second bracket and the tow loop such that the tow loop is rotatably coupled to the first and second brackets; the washer is disposed between the second bracket and the tow loop; the tow loop includes a first arm and a second arm that is spaced apart from the first arm; the washer includes a first washer and a second washer, the first washer rotationally fixed to the first arm of the tow loop and the second washer rotationally fixed to the second arm of the tow loop; the biasing member engages one tooth of the plurality of teeth when the tow loop is in the deployed position to inhibit movement of the tow loop in the second rotational direction; and the tow loop includes a body portion and an attachment portion extending from the body portion, the attachment portion is configured to be coupled to the first bracket when the tow loop is in the deployed position to further inhibit movement of the tow loop relative to the first bracket.

In yet another form, the present disclosure provides a vehicle that includes a vehicle body and a tow hook assembly coupled to the vehicle body. The tow hook assembly includes a bracket, a tow loop, and a biasing mechanism. The bracket is configured to be coupled to a body of the vehicle. The tow loop is rotatably coupled to the bracket between a stowed position and a deployed position. The biasing mechanism is configured to bias the tow loop towards the stowed position. The biasing mechanism includes a biasing member and at least one washer having a plurality of teeth. The biasing member engages the plurality of teeth when the tow loop is in the stowed position to inhibit movement of the tow loop in a first rotational direction and a second rotational direction that is opposite the first rotational direction.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a front view of a vehicle including a tow hook assembly in a deployed position in accordance with the teachings of the present disclosure;

FIG. 2 is a front view of a portion of the vehicle including the tow hook assembly of FIG. 1 in a stowed position;

FIG. 3 is a perspective view of the tow hook assembly of FIG. 1;

FIG.4 is another perspective view of the tow hook assembly of FIG. 1;

FIG. 5 is an exploded view of the tow hook assembly of FIG. 1;

FIG. 6 is a cross-sectional view of the tow hook assembly of FIG. 1 in the stowed position;

FIG. 7 is a cross-sectional view of the tow hook assembly of FIG. 1 being moved from the stowed position towards the deployed position; and

FIG. 8 is a cross-sectional view of the tow hook assembly of FIG. 1 in the deployed position.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

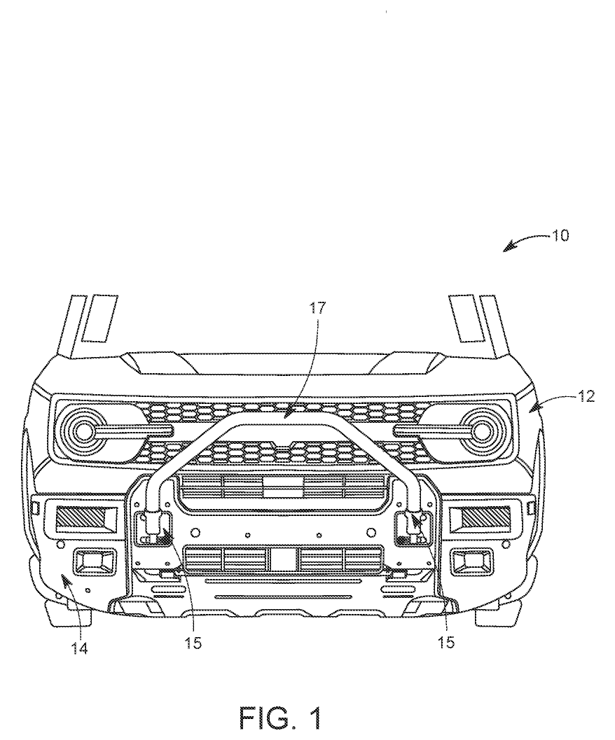

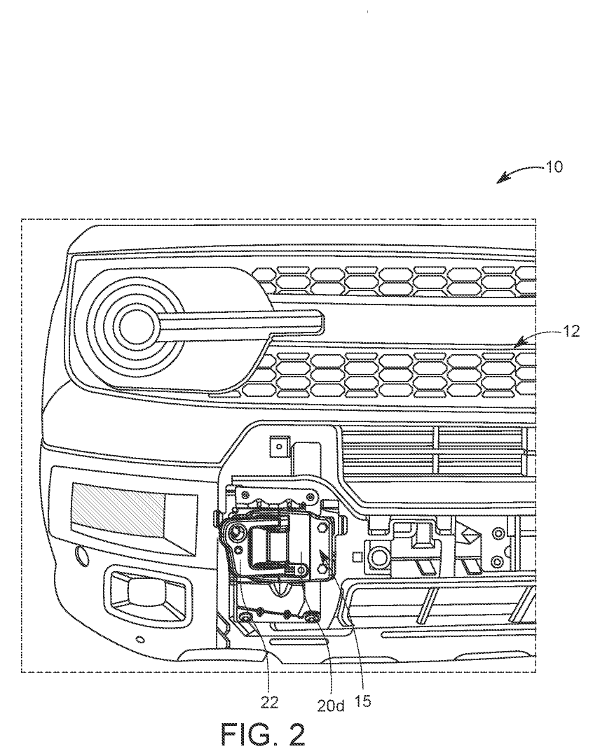

With reference to FIGS. 1 and 2, a vehicle 10 is illustrated. The vehicle 10 includes a vehicle body 12 and a plurality of tow hook assemblies 15. The vehicle body 12 may include a front end 14 and an aft end (not shown) and may define an occupant cabin accommodating passengers.

Each tow hook assembly 15 is coupled to the front end 14 of the vehicle body 12 (e.g., a frame of the vehicle body 12) and is movable between a stowed position (FIG. 2) and a deployed position (FIG. 1). When in the stowed position, the tow hook assembly 15 is folded towards the vehicle body 12 thereby facilitating assembly of the vehicle 10, for example, while inhibiting operator interference with the tow hook assembly 15. When in the deployed position, the tow hook assembly 15 may be connected to additional accessories, such as a nudge bar 17, for example, thereby enhancing the vehicle’s functionality and customization options. The tow hook assembly 15 may be conveniently moved between the stowed position and the deployed position which will be described herein in detail.

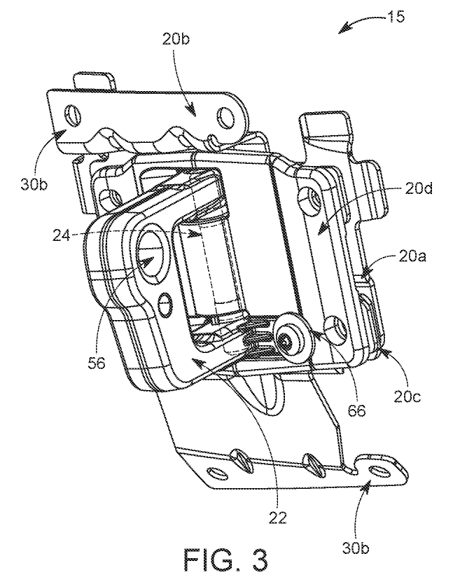

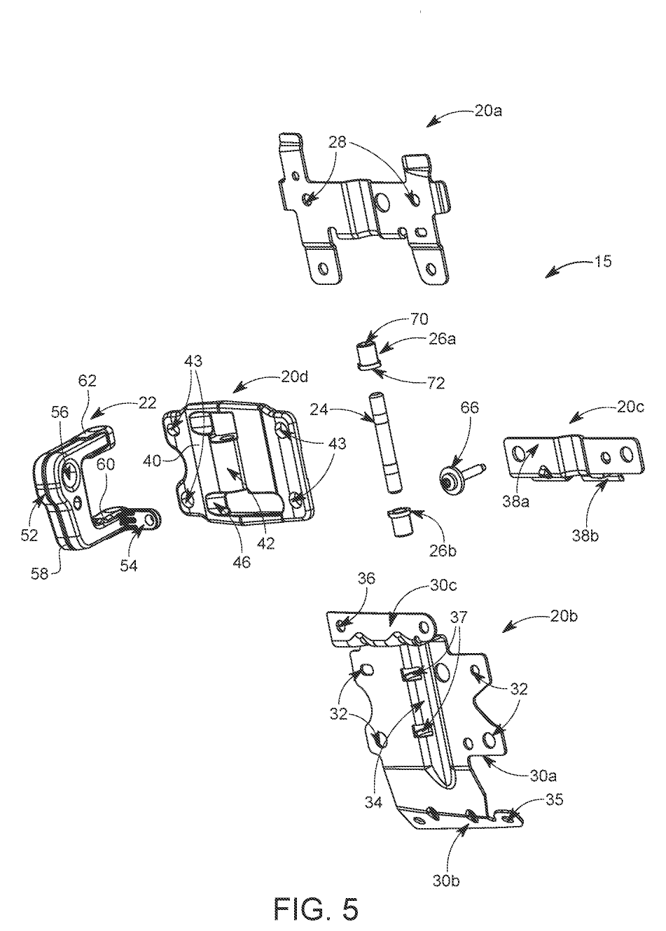

With additional reference to FIGS. 3-5, the tow hook assembly 15 is mounted to the front end 14 of the vehicle body 12 and includes a plurality of brackets 20a, 20b, 20c, 20d, a tow loop or tow hook 22, a pin 24 (FIGS. 3 and 5), and a plurality of washers 26a, 26b. In some forms, the tow hook assembly 15 may be mounted to other locations of the vehicle body 12 (e.g., an aft end of the vehicle body 12) without departing from the scope of the present disclosure. With reference to FIG. 5, the bracket 20a is fixed to a front end of the vehicle body 12 and includes a plurality of apertures 28 formed therein. Stated differently, the bracket 20a is fixed to the vehicle body 12 via mechanical fasteners (not shown) extending through the apertures 28 and partially through the vehicle body 12 and/or welding the bracket 20a to the frame of the vehicle body 12. In this way, the bracket 20a is supported by the vehicle body 12.

The bracket 20b is fixed to the front end of the vehicle body 12 and is coupled to the backet 20a. In this way, the bracket 20a is disposed between the bracket 20b and the vehicle body 12. The bracket 20b includes a body portion 30a, a first extension portion 30b and a second extension portion 30c. The body portion 30a includes a plurality of apertures 32, a groove 34, and a plurality of biasing members 37 (e.g., springs). Mechanical fasteners (not shown) may extend through the plurality of apertures 32 of the bracket 20b, the apertures 28 of the bracket 20a and the vehicle body 12, thereby securing the brackets 20a, 20b to the vehicle body 12. The groove 34 may be positioned between pairs of apertures 32 and extends toward the vehicle body 12. The groove 34 may have a semi-circular shape and may receive a portion of the bracket 20d as will be described in more detail below. The first extension portion 30b may extend from a first end of the body portion 30a towards the vehicle body 12 and may include a plurality of apertures 35. Mechanical fasteners (not shown) may extend through the plurality of apertures 35 and partially through the vehicle body 12, thereby further securing the brackets 20a, 20b to the vehicle body 12. The second extension portion 30c may extend from a second opposing end of the body portion 30a away from the vehicle body 12 and may include a plurality of apertures 36. Mechanical fasteners (not shown) may extend through the plurality of apertures 36 and partially through the vehicle body 12, thereby further securing the brackets 20a, 20b to the vehicle body 12.

The biasing members 37 are configured to bias the tow hook 22 towards the stowed position as will be described in more detail below. The biasing members 37 extend from the body portion 30a of the bracket 20b and are partially located within the groove 34. The biasing members 37 are spaced apart from each other and have an arcuate profile. Each biasing member 37 moves toward a respective cutout 39 of the bracket 20b as the tow hook 22 moves toward the deployed position as will be described in more detail below. The bracket 20b of the present disclosure includes two biasing members 37. However, the bracket 20b may include one biasing member or more than two biasing members without departing from the scope of the present disclosure.

The bracket 20c is secured to the brackets 20a, 20b, 20d and includes a first portion 38a and a second portion 38b that extends at an angle (e.g., perpendicular) from the first portion 38a. The first portion 38a is located between the brackets 20a, 20b and receives mechanical fasteners (not shown) extending through the brackets 20a, 20b, 20d and partially through the vehicle body 12 to secure the brackets 20a, 20b, 20c, 20d to the vehicle body 12. The second portion 38b extends toward the vehicle body 12 and is configured to receive mechanical fasteners (not shown), thereby further securing the bracket 20c to the vehicle body 12.

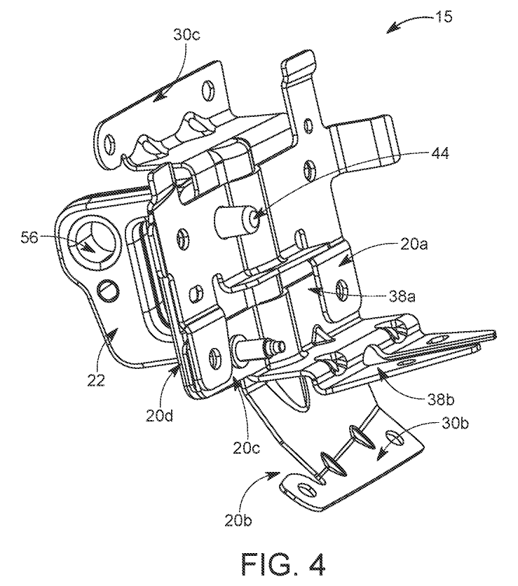

The bracket 20d is secured to the brackets 20a, 20b, 20c and includes a body portion 40 and a housing 42. The body portion 40 defines a plurality of apertures 43 and a cutout 46 and includes a protrusion 44 (FIG. 4). Mechanical fasteners (not shown) may extend through the plurality of apertures 32 of the bracket 20b, the apertures 28 of the bracket 20a, the bracket 20c, the apertures 43 of the bracket 20d, and partially through the vehicle body 12, thereby securing the brackets 20a, 20b, 20c, 20d to the vehicle body 12. The protrusion 44 may extend from the body portion 40 through the brackets 20a, 20b, and partially through the vehicle body 12. In this way, the protrusion 44 may facilitate positioning of the tow hook assembly 15 relative to the vehicle body 12. The cutout 46 is positioned between pairs of the apertures 43. In the example illustrated, the housing 42 has a cylindrical shape and is disposed within the cutout 46 of the body portion 40. The housing 42 is coupled to a periphery of the body portion 40 that defines the cutout 46 and extends into the groove 34 of the bracket 20b.

The tow loop 22 is rotatably coupled to the brackets 20b and 20c between the stowed position (FIG. 1) and the deployed position (FIG. 2). When the tow loop 22 is in the stowed position, the bracket 20b and a location A along a periphery of the tow hook 22 defines a first distance X1. When the tow loop 22 is in the deployed position, the bracket 20b and the location A along the periphery of the tow hook 22 defines a second distance X2. The second distance X2 is greater than the first distance X1. Stated differently, when the tow loop 22 is in the deployed position, the tow loop 22 extends further away from the brackets 20a-20d and the vehicle body 12 then when the tow loop 22 is in the stowed position.

In the example illustrated, the tow loop 22 has a U-shape or C-shape profile and includes a body portion 52 and an attachment portion 54 extending from the body portion 52. The body portion 52 defines one or more apertures 56 extending therethrough. In this way, the tow loop 22 may be coupled to accessories, such as the nudge bar 17, for example, when the tow loop 22 is in the deployed position. The tow loop 22 also includes a connecting portion 58, a first arm 60 extending from a first end of the connecting portion 58 and a second arm 62 extending from a second opposing end of the connecting portion 58. In the example illustrated, the first arm 60 has a length that is greater than a length of the second arm 62. In some forms, the first arm 60 may have a length that is equal to or less than the length of the second arm 62. In the example illustrated, the location A is an intersection between the connecting portion 58 and the first arm 60.

The attachment portion 54 extends from the body portion 52 and is configured to retain the tow hook 22 in the deployed position (i.e., inhibit movement of the tow loop 12 relative to the vehicle body 12). That is, a fastener 66 extends through the attachment portion 54, the brackets 20b, 20c, 20d and the vehicle body 12 when the tow hook 22 is in the deployed position, thereby further supporting the tow hook 22 to the vehicle body 12 in the deployed position. In the example illustrated, the attachment portion 54 extends from the second arm 62. In some forms, the attachment portion 54 may extend from the first arm 60 or the connecting portion 58.

The pin 24 extends through the housing 42 of the bracket 20d, partially through the first arm 60 of the tow hook 22, and partially through the second arm 62 of the tow hook 22. In this way, the tow hook 22 is rotatably coupled to the bracket 20d via the pin 24. Stated differently, the tow hook 22 rotates about a longitudinal axis 24a of the pin 24 that extends in a vertical direction of the vehicle 10.

The plurality of washers 26a, 26b are configured to cooperate with the biasing members 37 of the bracket 20b to bias the tow hook 22 towards the stowed position. In this way, the washers 26a, 26b and the biasing members 37 form a biasing mechanism. In the example illustrated, each washer 26a, 26b is disposed between the tow hook 22 and the housing 42 of the bracket 20d. That is, the washer 26a is disposed between the first arm 60 of the tow hook 22 and the housing 42 and the washer 26b is disposed between the second arm 62 of the tow hook 22 and the housing 42.

The plurality of washers 26a, 26b are rotationally fixed to the tow hook 22 such that rotation of the tow hook 22 rotates the washers 26a, 26b. Each washer 26a, 26b is coaxial with the pin 24 and includes a body portion 70 and a washer portion 72. The body portion 70 of the washer 26a extends partially through the first arm 60 of the tow hook 22 such that the washer 26a is rotationally fixed to the tow hook 22. Similarly, the body portion 70 of the washer 26b extends partially through the second arm 62 of the tow hook 22 such that the washer 26b is rotationally fixed to the tow hook 22.

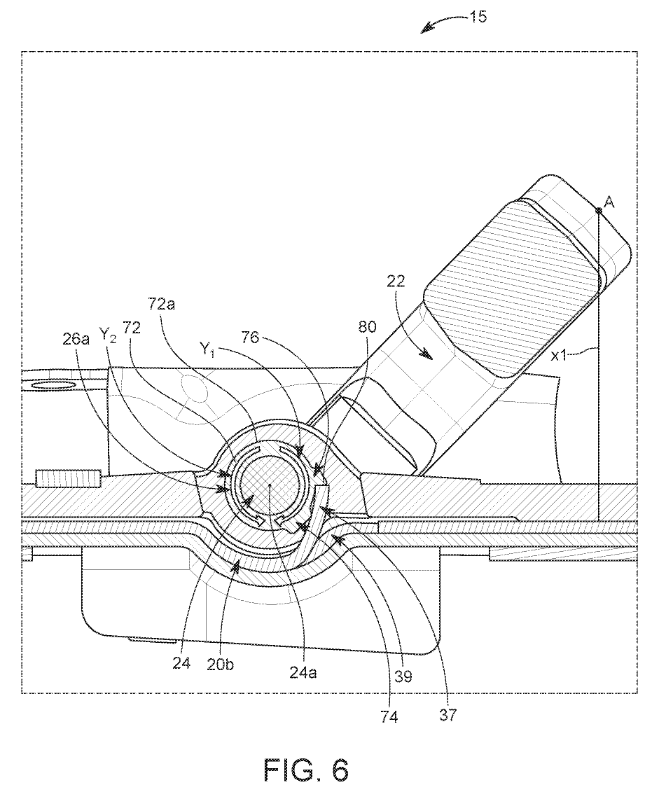

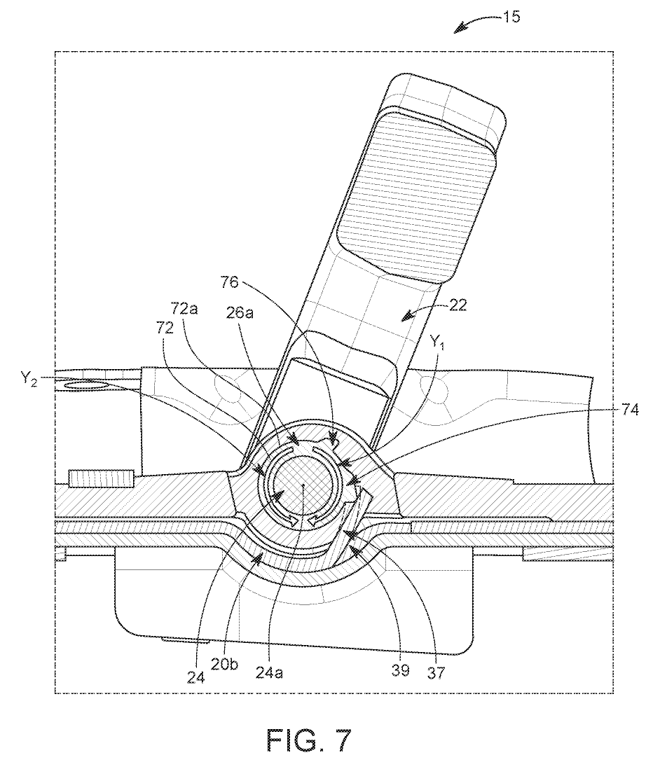

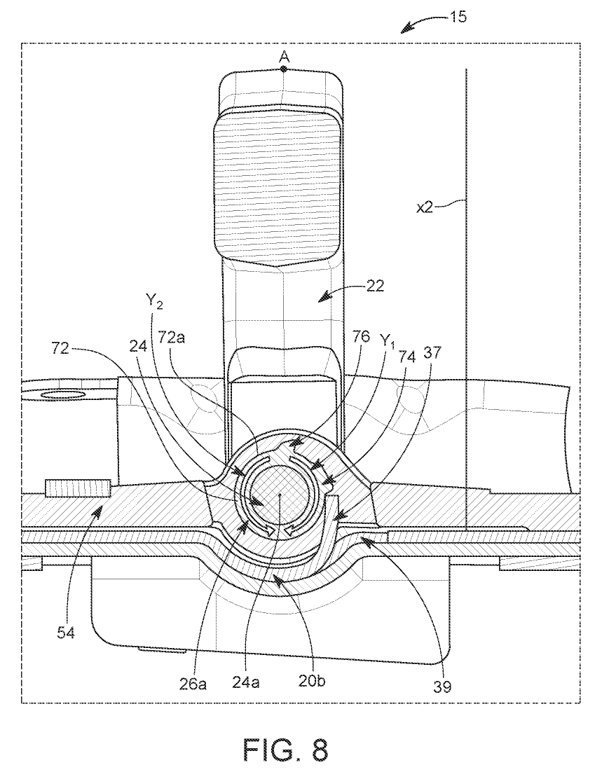

With reference to FIGS. 6-8, the washer portion 72 includes a plurality of teeth 74, 76 located on a circumferential surface 72a of the washer portion 72. The circumferential surface 72a of the washer portion 72 has a diameter that is greater than a diameter of the body portion 70. As shown in FIG. 6, the biasing member 37 engages the tooth 74 of the washer 26a, 26b to bias the tow hook 22 in a first rotational direction Y1. The biasing member 37 also engages a surface 80 of the tooth 76 when the tow hook 22 is in the stowed position to inhibit further rotation in the first rotational direction Y1. As shown in FIG. 7, a force may overcome the biasing force of the biasing member to such that the tow hook 22 is moved in a second rotational direction Y2 towards the deployed position. It should be understood that the biasing member 37 moves away from the washer 26a, 26 and towards the cutout 39 as the tow hook 22 moves towards the deployed position. As shown in FIG. 8, the biasing member 37 engages the tooth 74 and is spaced apart from the tooth 76 when the tow hook 22 is in the deployed position. The biasing member 37 engages a different surface of the tooth 74 when the tow hook 22 is in the deployed than when the tow hook 22 is in the stowed position (compare FIGS. 6 and 8). Once the tow hook 22 is in the deployed position, the fastener 66 extends through the attachment portion 54, the brackets 20b, 20c, 20d and partially through the vehicle body 12 thereby further supporting the tow hook 22 to the vehicle body 12 in the deployed position. The tow hook 22 may be moved back to the stowed position by removing the fastener 66 and applying a force to the tow hook 22 that overcomes the biasing force of the biasing member 37 to such that the tow hook 22 is moved in the first rotational direction Y1 towards the stowed position.

It should be understood that the washers 26a, 26b may include additional teeth between teeth 74, 76. In this way, the tow hook 22 may be moved in a ratcheting movement between the stowed position and deployed position. Although the teeth 74, 76 are coupled to the washers 26a, 26b and the biasing members 37 are coupled to the bracket 20b, in some configurations, the teeth 74, 76 may be coupled to the bracket 20b and the biasing members 37 may be coupled to the washers 26a, 26b without departing from the scope of the present disclosure.

The tow hook assembly 15 of the present disclosure provides the benefit of allowing the tow hook 22 to be conveniently moved between the stowed position and the deployed position as desired. For example, it may be desirable to fold the tow hook 22 when the vehicle 10 is being assembled, thereby facilitating assembly of the vehicle 10 while inhibiting operator interference with the tow hook assembly 15. In another example, it may be desirable to move the tow hook 22 to the deployed position to connect accessories, such as a nudge bar 17, thereby enhancing the vehicle’s functionality and customization options.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A tow hook assembly for a vehicle, the tow hook assembly comprising:
a first bracket configured to be coupled to a body of the vehicle;
a tow loop rotatably coupled to the first bracket between a stowed position and a deployed position; and
a biasing mechanism configured to bias the tow loop towards the stowed position, the biasing mechanism includes a biasing member and at least one washer having a plurality of teeth, the biasing member engaging a first tooth of the plurality of teeth when the tow loop is in the stowed position to inhibit movement of the tow loop in a first rotational direction.

2. The tow hook assembly of claim 1, wherein the biasing member is coupled to the first bracket and the at least one washer is coupled to the tow loop.

3. The tow hook assembly of claim 1, wherein the at least one washer is rotationally fixed to the tow loop.

4. The tow hook assembly of claim 1, further comprising:
a second bracket fixed to the first bracket; and
a pin extending partially through the second bracket and the tow loop such that the tow loop is rotatably coupled to the first and second brackets.

5. The tow hook assembly of claim 4, wherein the at least one washer is disposed between the second bracket and the tow loop.

6. The tow hook assembly of claim 1, wherein:
the tow loop includes a first arm and a second arm that is spaced apart from the first arm; and
the at least one washer includes a first washer and a second washer, the first washer rotationally fixed to the first arm of the tow loop and the second washer rotationally fixed to the second arm of the tow loop.

7. The tow hook assembly of claim 1, wherein the biasing member engages the first tooth of the plurality of teeth when the tow loop is in the deployed position to inhibit movement of the tow loop in a second rotational direction that is opposite the first rotational direction.

8. The tow hook assembly of claim 1, wherein the tow loop includes a body portion and an attachment portion extending from the body portion, and wherein the attachment portion is configured to be coupled to the first bracket when the tow loop is in the deployed position to further inhibit movement of the tow loop relative to the first bracket.

9. The tow hook assembly of claim 1, wherein the tow loop includes a connecting portion and first and second arms extending from opposing ends of the connecting portion, and wherein the tow loop further includes an attachment portion extending from one of the first and second arms and configured to be coupled to the first bracket when the tow loop is in the deployed position to further inhibit movement of the tow loop relative to the first bracket.

10. The tow hook assembly of claim 1, wherein the tow loop includes an aperture that is configured to receive a fastener to couple the tow loop to a nudge bar.

11. The tow hook assembly of claim 1, wherein the first bracket and a periphery of the tow loop defines a first distance when the tow loop is in the stowed position, and wherein the first bracket and the periphery of the tow loop defines a second distance when the tow loop is in the deployed position, the second distance is greater than the first distance.

12. The tow hook assembly of claim 1, wherein the biasing member engages a second tooth of the plurality of teeth when the tow loop is in the stowed position to inhibit movement of the tow loop in a second rotational direction that is opposite the first rotational direction.

13. A tow hook assembly for a vehicle, the tow hook assembly comprising:
a first bracket configured to be coupled to a body of the vehicle;
a tow loop rotatably coupled to the first bracket between a stowed position in which the first bracket and a periphery of the tow loop defines a first distance and a deployed position in which the first bracket and the periphery of the tow loop defines a second distance, the second distance greater than the first distance; and
a biasing mechanism configured to bias the tow loop towards the stowed position, the biasing mechanism includes a biasing member coupled to the first bracket and at least one washer coupled to the tow loop and having a plurality of teeth, the biasing member engaging the plurality of teeth when the tow loop is in the stowed position to inhibit movement of the tow loop in a first rotational direction and a second rotational direction that is opposite the first rotational direction.

14. The tow hook assembly of claim 13, wherein the at least one washer is rotationally fixed to the tow loop.

15. The tow hook assembly of claim 13, further comprising:
a second bracket fixed to the first bracket; and
a pin extending partially through the second bracket and the tow loop such that the tow loop is rotatably coupled to the first and second brackets.

16. The tow hook assembly of claim 15, wherein the at least one washer is disposed between the second bracket and the tow loop.

17. The tow hook assembly of claim 13, wherein:
the tow loop includes a first arm and a second arm that is spaced apart from the first arm; and
the at least one washer includes a first washer and a second washer, the first washer rotationally fixed to the first arm of the tow loop and the second washer rotationally fixed to the second arm of the tow loop.

18. The tow hook assembly of claim 13, wherein the biasing member engages one tooth of the plurality of teeth when the tow loop is in the deployed position to inhibit movement of the tow loop in the second rotational direction.

19. The tow hook assembly of claim 13, wherein the tow loop includes a body portion and an attachment portion extending from the body portion, and wherein the attachment portion is configured to be coupled to the first bracket when the tow loop is in the deployed position to further inhibit movement of the tow loop relative to the first bracket.

20. A vehicle comprising:
a vehicle body; and
a tow hook assembly coupled to the vehicle body, the tow hook assembly comprising:
a bracket configured to be coupled to a body of the vehicle;
a tow loop rotatably coupled to the bracket between a stowed position and a deployed position; and
a biasing mechanism configured to bias the tow loop towards the stowed position, the biasing mechanism includes a biasing member and at least one washer having a plurality of teeth, the biasing member engaging the plurality of teeth when the tow loop is in the stowed position to inhibit movement of the tow loop in a first rotational direction and a second rotational direction that is opposite the first rotational direction.
